(19) United States
(12) Patent Application Publication
(10) Pub. No.: US 2008/0274759 A1
(43) Pub. Date: Nov. 6, 2008

(54) System and Method for Controlling Base Stations for Multimedia Broadcast Communications

(76) Inventors: Hongyuan Chen, Tokyo (JP); Huang Leping, Tokyo (JP); Kodo Shu, Kawasaki (JP)

Correspondence Address: SLATER & MATSIL, L.L.P., 17950 PRESTON RD, SUITE 1000, DALLAS, TX, 75252-5793, US

(21) Appl. No.: 12/114,390

(22) Filed: May 2, 2008

Related U.S. Application Data
(60) Provisional application No. 60/927,856, filed on May 4, 2007.

(51) Int. Cl. H04Q 7/00

(52) U.S. Cl. 455/507

(57) ABSTRACT

A method, apparatus and system are provided for controlling base stations for multimedia broadcast communications. In one embodiment, an apparatus includes a reporting subsystem configured to compile an activity status report based on a counting report and a channel quality indicator report received from user equipment and to send the activity status report to an entity of the communication system. The apparatus also includes a dynamic single-frequency network subsystem configured to control a multimedia broadcast and multimedia multicast service provided by the apparatus as a function of a static contribution table associated therewith and the activity status report.

This application claims the benefit of U.S. Provisional Application No. 60/927,856 entitled “System and Method for Controlling Base Stations for Multimedia Broadcast Communications,” filed on May 4, 2007, which is incorporated herein by reference.

### TECHNICAL FIELD

The present invention is directed, in general, to communication systems and, in particular, to point-to-multipoint communications in a wireless communication system.

### BACKGROUND

Broadcast and multicast communications are a form of point-to-multipoint communications in which information is simultaneously transmitted from a single source to multiple destinations. Broadcast and multicast communications are used in a cellular communication system to transmit emergency or general alert messages, such as a weather alert, to a large number of people in an area of interest. Such communications provide an alternative path to customary radio and television alerts, and have the advantage that they can be focused on a particular receiving group or a particular receiving area.

The Third Generation Partnership Project Long Term Evolution (“3GPP LTE”) is the name generally used to describe an ongoing effort across the industry to improve the universal mobile telecommunications system (“UMTS”) for mobile communications to cope with continuing new requirements and the growing base of users. The goals of this broadly based project include improving communication efficiency, lowering costs, improving services, making use of new spectrum opportunities, and achieving better integration with other open standards. The 3GPP LTE project is not itself a standard-generating effort, but will result in new recommendations for standards for the UMTS. The term multimedia broadcast and multimedia multicast service (“MBMS”) is 3GPP terminology that refers to broadcast and multicast services and related systems associated therewith.

A single-frequency network (“SFN”) is a transmission mode employed in long-term evolution multimedia broadcast and multimedia multicast service wherein several transmitters simultaneously transmit the same signal over the same frequency channel. A single-frequency network is also called a multicast broadcast single-frequency network (“MBSFN”) or multi-cell point-to-multipoint (“multi-cell PtM”) mode. Thus, single-frequency network operation implies content synchronization of base stations transmitting a multimedia broadcast and multimedia multicast service within, for instance, an associated deployment area. A multimedia broadcast and multimedia multicast service can be transmitted within a cyclic prefix length of a few microseconds as seen by user equipment receiving the multimedia broadcast and multimedia multicast service from the base stations. (See, e.g., 3GPP TR R3.018, entitled “3rd Generation Partnership Project; Technical Specification Group Radio Access Network; Evolved UTRA and UTRAN; Radio Access Architecture and Interfaces (Release 7),” Version 7.1 (February 2007), which is incorporated herein by reference.)

The UMTS terrestrial radio access network (“UTRAN”) is a part of a UMTS network that includes one or more radio network controllers (“RNCs”) and one or more nodes. An evolved UTRAN (“E-UTRAN”) provides new physical layer concepts and protocol architectures for the UMTS. While the discussion that follows is directed to multimedia broadcast and multimedia multicast services for a 3GPP LTE E-UTRAN employing single-frequency network transmission, the concepts as described herein are applicable to any multimedia broadcast communications and networks.

The multimedia broadcast and multimedia multicast services often operate with a synchronized single-frequency network. In the event that a service provider wishes to provide nationwide service and does not form a nationwide single-frequency network, the service can instead form localized single-frequency networks from multiple cells, and then form a nationwide broadcast network from the multiple localized asynchronous single-frequency networks. In this arrangement, the same multimedia broadcast and multimedia multicast services are provided in every localized single-frequency network. Issues arise, however, when user equipment moves between single-frequency networks. The issues that arise are similar to those that currently exist in analog television broadcasting, wherein users change channels or frequencies when moving across the border of two broadcast areas. This limitation is much more pronounced in multimedia broadcast and multimedia multicast services for 3GPP LTE E-UTRANs since one single-frequency network area therein is typically smaller than a conventional digital/analog broadcasting service coverage area.

Accordingly, what is needed in the art is a system and method that controls base stations for multimedia broadcast communications, especially for multimedia broadcast and multimedia multicast services for 3GPP LTE E-UTRANs employing a single-frequency network, avoiding the limitations of the present communication systems.

### SUMMARY OF THE INVENTION

These and other problems are generally solved or circumvented, and technical advantages are generally achieved, by embodiments of the present invention, which include a method, apparatus, and system for controlling base stations for multimedia broadcast communications. In one embodiment, an apparatus (e.g., a base station) includes a reporting subsystem configured to compile an activity status report based on a counting report and a channel quality indicator report received from user equipment and to send the activity status report to an entity (e.g., a multi-cell multimedia broadcast and multimedia multicast service coordination entity) of the communication system. The apparatus also includes a dynamic single-frequency network subsystem configured to control a multimedia broadcast and multimedia multicast service provided by the apparatus as a function of a static contribution table associated therewith and the activity status report. The static contribution table is derivable by a multi-cell multimedia broadcast and multimedia multicast service coordination entity of the communication system and is a function of a geographical layout of the apparatus with other entities of the communication system.

In another aspect, the present invention provides an apparatus (e.g., a multi-cell multimedia broadcast and multimedia multicast service coordination entity) operable in a single-frequency network associated with a communication system. The apparatus includes a dynamic single-frequency network subsystem configured to receive an activity status report (e.g., based on a counting report and a channel quality indicator report) associated with user equipment from a base station, derive a static contribution table associated with the base station, and produce a command to control a behavior of the base station as a function of the activity status report and the static contribution table. The apparatus also includes an interface subsystem configured to send the command to the base station. The static contribution table is a function of a geographical layout of the base station with other entities of the communication system. The static contribution table may also include zones as a function of geographical relation between an entity of the communication system and the base station to estimate a single-frequency network combining gain contribution of the user equipment.

Additionally, the dynamic single-frequency network subsystem of the apparatus is configured to produce the command as set forth below. If at least one user equipment is receiving a multimedia broadcast and multimedia multicast service in a critical zone of the base station, the dynamic single-frequency network subsystem produces a command to leave on a multimedia broadcast and multimedia multicast service associated with the base station. If all user equipment receiving multimedia broadcast and multimedia multicast service is within a negligible zone of the base station, the dynamic single-frequency network subsystem produces a command to turn off the multimedia broadcast and multimedia multicast service associated with the base station. If no user equipment is in the critical zone of the base station and at least one user equipment receiving multimedia broadcast and multimedia multicast service is in a gray zone thereof, and if user equipment channel quality indicator report related to the base station is available in the activity status report, the dynamic single-frequency network subsystem produces a command to turn off the multimedia broadcast and multimedia multicast service associated with the base station.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the invention, and the advantages thereof, reference is now made to the following descriptions taken in conjunction with the accompanying drawing, in which:

FIG. 1 illustrates a diagram demonstrating a multi-cell multimedia broadcast and multimedia multicast services synchronization area that provides an environment for application of the principles of the present invention;

FIG. 2 illustrates a diagram demonstrating exemplary synchronization parameters associated with a single-frequency network in accordance with the principles of the present invention;

FIGS. 3 and 4 illustrate system level diagrams of embodiments of communication networks and systems that provide an environment for application of the principles of the present invention;

FIG. 5 illustrates a system level diagram of a communication element of a communication system that provides an environment for application of the principles of the present invention;

FIGS. 6 and 7 illustrate block diagrams of embodiments of communication systems constructed in accordance with the principles of the present invention;

FIG. 8 illustrates a graphical representation of a static contribution table constructed according to the principles of the present invention;

FIG. 9 illustrates a diagram representing a static contribution table constructed according to the principles of the present invention;

FIG. 10 illustrates a flow diagram of an embodiment of a method of operating a communication system constructed according to the principles of the present invention; and

FIGS. 11 and 12 illustrate signaling diagrams demonstrating exemplary operations of a communication system employing a distributed architecture and a centralized architecture, constructed according to the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. While the concepts described herein are applicable to multimedia broadcast communications and networks, in general, the description that follows is directed to multimedia broadcast and multimedia multicast services for 3GPP LTE E-UTRANs employing single-frequency networks.

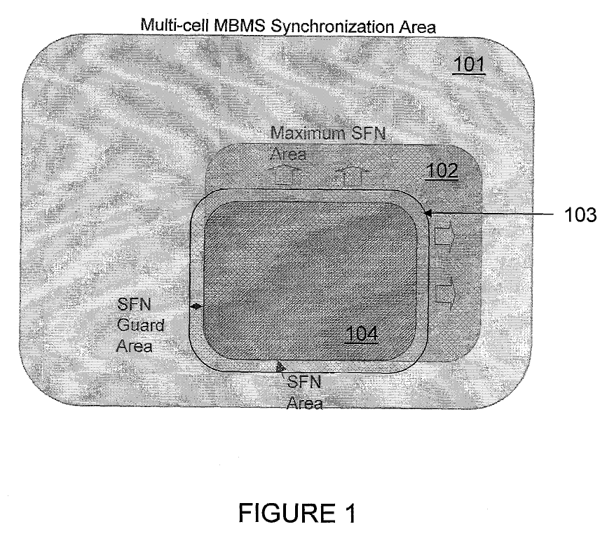

Referring initially to FIG. 1, illustrated is a diagram demonstrating a multi-cell multimedia broadcast and multimedia multicast services synchronization area that provides an environment for application of the principles of the present invention. A multi-cell multimedia broadcast and multimedia multicast service (“MBMS”) synchronization area 101 generally includes a group of cells having the same frequency band allocated with contiguous coverage, in which the cells may be synchronized and may transmit MBMS data in a single-frequency network transmission mode. The multi-cell MBMS synchronization areas 101 may be configured independently from MBMS service area configurations with the capability of supporting one or more single-frequency network areas. For a given geographical area and a given frequency band preferably one multi-cell MBMS synchronization area 101 is defined (i.e., multiple multi-cell MBMS synchronization areas 101 in the same geographical area are defined on different frequency bands).

In addition to the discussion above, a single-frequency network (“SFN”) area includes a group of cells with contiguous coverage wherein the cells use the same radio resources in the same frequency band to synchronously transmit a single multimedia broadcast and multimedia multicast service. An SFN area 104 preferably belongs to one multi-cell MBMS synchronization area 101 and includes the actively transmitting cells at a certain point in time. Additionally, a maximum SFN area 102 supports geographical extension of an SFN area 104 and may be limited by the multi-cell MBMS synchronization area 101, MBMS service area and operator configuration. An SFN guard area 103 is a group of cells wherein the use of the same radio resources is restricted due to interference considerations as a result of resource usage in the corresponding SFN area. For a better understanding of the foregoing, see Section 6.19.2.1.1 of 3GPP TR R3.018, cited above.

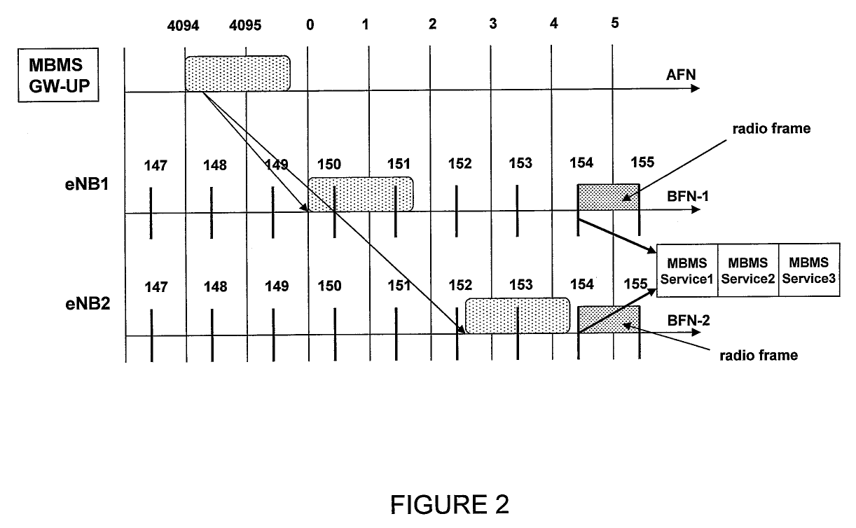

Turning now to FIG. 2, illustrated is a diagram demonstrating exemplary synchronization parameters associated with a single-frequency network in accordance with the principles of the present invention. The communication system elements illustrated in FIG. 2 include a multimedia broadcast and multimedia multicast service gateway user plane (designated “MBMS GW-UP”), and first and second base stations (designated “eNB1” and “eNB2,” respectively). At the physical layer, frame timing (e.g., at the microsecond level) of each base station in an SFN area is preferably aligned at a start boundary of each frame to ensure the physical layer framing time synchronization. Regarding content level transmission, the same content of a multimedia broadcast and multimedia multicast service should be transmitted at the same time by each base station in an SFN area to ensure that the same content can be combined in time at the user equipment. Regarding resource block allocation, the physical resource block allocation pattern in each transmission time interval should be coincident for the base stations in an SFN area to ensure that the same resource block is used for the same multimedia broadcast and multimedia multicast service data from the different base stations. For a better understanding of the foregoing, see Section 6.19.2.1.2 of 3GPP TR R3.018, cited above. For purposes of the illustration, BFN refers to the base station frame number counter as the network synchronization reference, which is typically in a range from 0 to 4095. Also, AFN refers to the MBMS GW-UP frame number counter as the network synchronization reference, which is typically in a range from 0 to 4095. Studying the possibility of dynamically adjusting the size of an SFN area (referred to as “dynamic SFN”) may be advantageous. One possibility is to make SFN areas dynamically based on user equipment movement. Some expected benefits from dynamic SFN include more capacity for unicast communications, reuse of radio resources between multiple multimedia broadcast and multimedia multicast services and easier interference conditions on the SFN area borders (i.e., improvement in performance and multimedia broadcast and multimedia multicast service continuity at the edge of the cells).

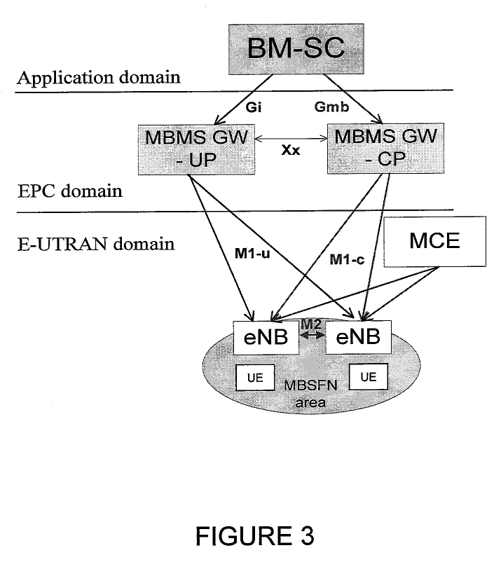

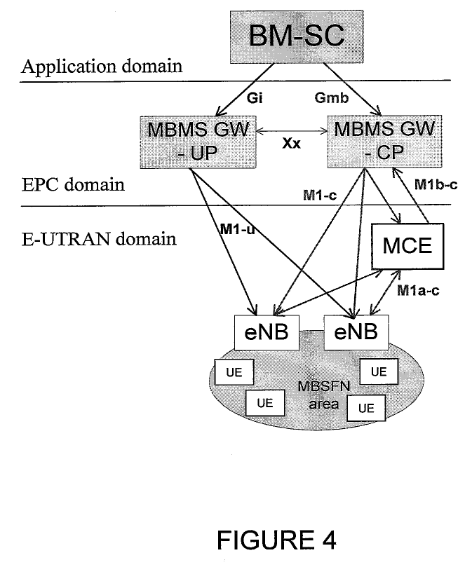

Turning now FIGS. 3 and 4, illustrated are system level diagrams of embodiments of communication networks and systems that provide an environment for application of the principles of the present invention. The communication networks include 3GPP LTE E-UTRANs employing single-frequency network transmission. The communication networks of FIGS. 3 and 4 demonstrate light and general deployment, respectively. A property of the light deployment is that a functionality of a multi-cell multimedia broadcast and multimedia multicast service coordination entity (“MCE”) is semi-statically or statically configured in the relevant nodes.

The communication networks include an application domain with a broadcast/multicast service center (“BM-SC”). The BM-SC serves as an entry point for content delivery services within the communication networks. The BM-SC configures and controls transport bearers for the multimedia broadcast and multimedia multicast services to a mobile core network (e.g., an evolved packet core domain and E-UTRAN domain) and schedules and delivers transmissions for the multimedia broadcast and multimedia multicast services. The BM-SC also provides service announcements for user equipment (“UE”) to join multimedia broadcast and multimedia multicast services such as, without limitation, a multicast service identifier, internet protocol multicast addresses, time of transmission, and media descriptions. The BM-SC can also be used to generate charging records for information transmitted by a content provider and to manage security functions specified by 3GPP for a multicast mode.

The communication networks also include an evolved packet core (“EPC”) domain with multimedia broadcast and multimedia multicast service gateways (“MBMS GWs”). The EPC domain includes a multimedia broadcast and multimedia multicast service gateway user plane (“MBMS GW-UP”) and a multimedia broadcast and multimedia multicast service gateway control plane (“MBMS GW-CP”). During session initiation, the MBMS GW-UP assigns a private internet protocol (“IP”) multicast address used for a user data stream distribution towards the base stations. The MBMS GW-UP entity is responsible for forwarding from BM-SC received IP packets to the base stations that have joined the private IP multicast group of a particular MBMS stream. In case of single-frequency network transmission mode, the MBMS GW-UP adds to the forwarded data unit's information based on which the base stations are able to have an air interface transmission synchronization. The interface between MBMS GW-UP and base stations is called M1-u. The MBMS GW-CP is a functional entity that takes care of the MBMS session management in the evolve packet core, which is terminated by a Gmb interface. The MBMS GW-CP delivers the MBMS session start/stop messages to the base stations part of the targeted multimedia broadcast and multimedia multicast service area. The interface between the MBMS GW-CP and base stations is called M1-c.

The main tasks for the MCE (also referred to as an MBMS radio resource management entity or operations and maintenance server) are to perform radio resource management and to define rules for data scheduling for the single-frequency network transmission mode among the cells that are part of the same SFN area. In addition, the MCE may be involved in the handling of counting results (e.g., in a shared carrier case). The major property of the light multimedia broadcast and multimedia multicast service deployment is that the MCE functionality is semi-statically or statically configured in the relevant nodes.

The communication networks also include an E-UTRAN domain with base stations (designated “eNB”) defining a multimedia broadcast single-frequency network (“MBSFN”) area for user equipment (“UE”) therein. The base station is responsible for the air interface operation. The base station controls the mapping of MBMS service areas to cells. In the single-frequency network transmission mode, the base stations that are part of the same SFN area should be synchronized. The pre-defined parameters are used when producing a transport block (“TB”) as well as for the radio resource management and scheduling to ensure unified output in the base stations of the SFN area. The termination for radio resource controller for single-frequency network transmission mode will depend on the multimedia broadcast and multimedia multicast service control channel (“MCCH”) concept and on the content of the radio resource control messages. The radio resource management in a single-frequency network transmission mode will require coordination between the cells, which are part of the SFN area. Counting is done on a cell basis and is therefore considered to be a task of the base station.

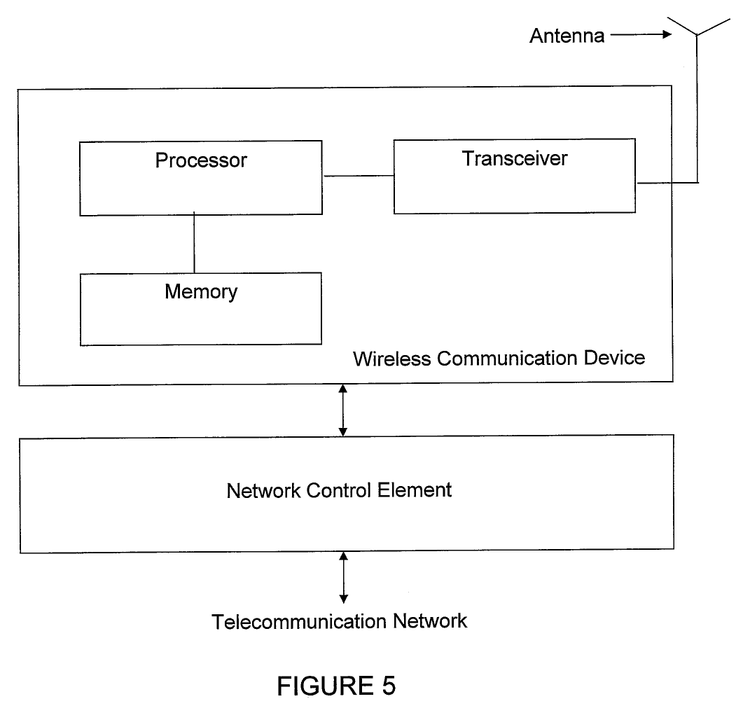

Turning now to FIG. 5, illustrated is a system level diagram of a communication element of a communication system that provides an environment for application of the principles of the present invention. The communication element may represent, without limitation, a base station, user equipment such as a mobile station, or a network control element. The communication element includes a processor, memory that stores programs and data of a temporary or more permanent nature, an antenna, and a radio frequency transceiver coupled to the antenna and the processor for bidirectional wireless communications. The communication element may provide point-to-point and/or point-to-multipoint communication services.

The communication element such as a base station in a cellular network may be coupled to a communication network element such as a network control element of a public switched telecommunication network. The network control element may, in turn, be formed with a processor, memory, and other electronic elements. The network control element preferably provides access to a telecommunication network such as a public switched telecommunication network. The access may be provided by a fiber optic, coaxial, twisted pair, or microwave communication link coupled to an appropriate link-terminating element. A communication element formed as a user equipment is generally a self-contained device intended to be carried by an end user.

The processor in the communication element, which may be implemented with a plurality of processing devices, performs functions associated with its operation including, without limitation, encoding and decoding of individual bits forming a communication message, formatting of information, and overall control of the communication element, including processes related to management of resources. Exemplary functions related to management of resources include, without limitation, hardware installation, traffic management, performance data analysis, tracking of end users and equipment, configuration management, and end user administration, management of user equipment, and management of tariffs, charging, and billing. The execution of all or portions of particular functions or processes related to management of resources may be performed in equipment separate from and coupled to the communication element, with the results of such functions or processes communicated for execution to the communication element. The processor of the communication element may be of any type suitable to the local application environment, and may include one or more of general-purpose computers, special purpose computers, microprocessors, digital signal processors (“DSPs”), and processors based on a multi-core processor architecture, as non-limiting examples. The processor and other elements of the communication element may also be built as integrated circuits on chips.

The transceiver of the communication element modulates information onto a carrier waveform for transmission by the communication element via the antenna to another communication element. The transceiver demodulates information received via the antenna for further processing by other communication elements.

The memory of the communication element as introduced above may be of any type suitable to the local application environment, and may be implemented using any suitable volatile or nonvolatile data storage technology such as a semiconductor-based memory device, a magnetic memory device and system, an optical memory device and system, fixed memory, and removable memory. The programs stored in the memory may include program instructions that, when executed by an associated processor, enable the communication element to perform tasks as described herein. Exemplary embodiments of the system, subsystems and modules as described herein may be implemented, at least in part, by computer software executable by processors of, for instance, the user equipment and the base station, or by hardware, or by combinations thereof. As will become more apparent, systems, subsystems and modules may be embodied in the communication element as illustrated and described above.

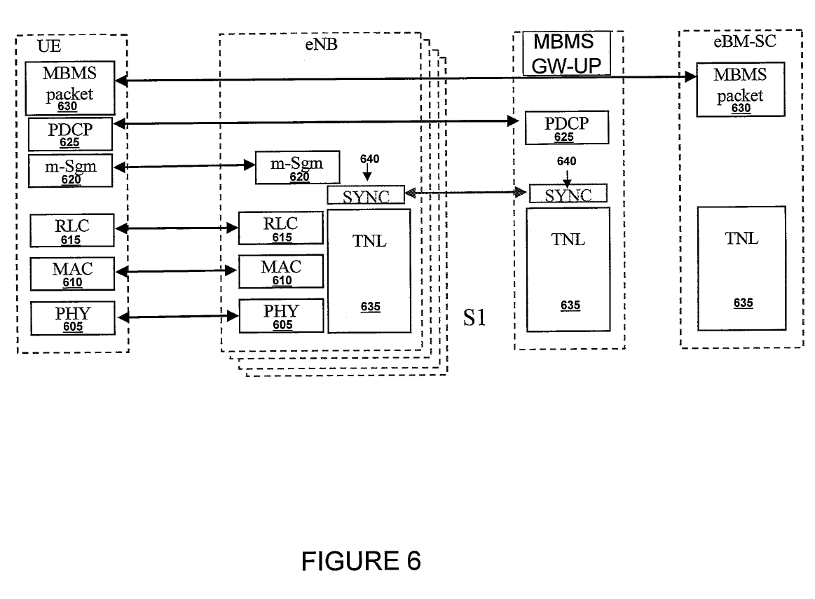

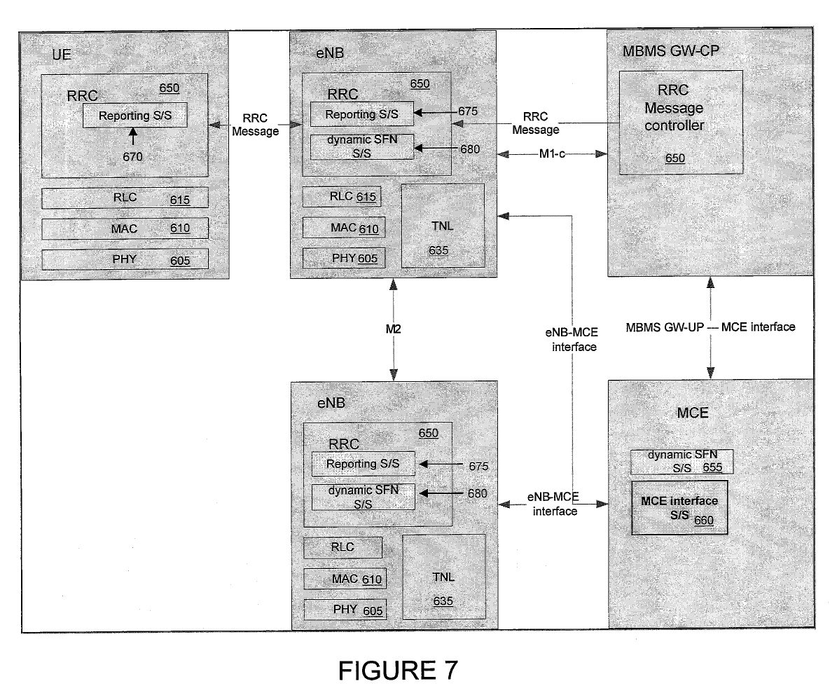

Turning now to FIGS. 6 and 7, illustrated are block diagrams of embodiments of communication systems in accordance with the principles of the present invention. Beginning with FIG. 6, illustrated is a user plane architecture of the systems architecture evolution bearer level content synchronization in supporting multimedia broadcast and multimedia multicast service single-frequency network operation including a broadcast/multicast service center (designated “eBM-SC”), a multimedia broadcast and multimedia multicast service gateway user plane (designated “MBMS GW-UP”), a base station (designated “eNB”) and user equipment (designated “UE”). The architecture is based on the functional allocation for unicast communications and includes a synchronization subsystem between a transport network layer and a packet data convergence protocol layer to support a level two content synchronization mechanism.

The user equipment includes a physical layer subsystem (designated “PHY”) 605, a media access controller (designated “MAC”) 610, a radio link controller (designated “RLC”) 615, a multimedia broadcast and multimedia multicast service segmentation entity (designated “m-Sgm”) 620, a packet data convergence protocol subsystem (designated “PDCP”) 625, and a multimedia broadcast and multimedia multicast service packet subsystem (designated “MBMS packet”) 630.

The physical layer subsystem 605 defines the electrical and the physical specifications for the interfaces for the user equipment. The media access controller 610 provides addressing and channel access control mechanisms for the user equipment. For instance, the media access controller 610 maps the multimedia broadcast and multimedia multicast service control channel (“MCCH”) and the multimedia broadcast and multimedia multicast service transport channel (“MTCH”) on a multicast channel (“MCH”) or a shared channel (“SCH”), depending on deployment scenarios, and schedules the transmission of MCCH and MTCH with proper timing and transport format. The radio link controller 615 provides error correction, retransmission, segmentation and reassembly of multimedia broadcast and multimedia multicast service data for the user equipment. For instance, assuming a radio link control unacknowledgement mode, the radio link controller 615 provides concatenation/segmentation under control of a centralized functionality.

The packet data convergence protocol subsystem 625 performs IP header compression and decompression, transfers multimedia broadcast and multimedia multicast service data, and maintains sequence numbers for radio bearers. In addition to the corresponding layers of the user equipment, the base station includes a transport network layer subsystem (designated “TNL”) 635. A synchronization subsystem (designated “SYNC”) 640 of the base station synchronizes the transmission of multimedia broadcast and multimedia multicast service data through the base station. The synchronization subsystem 640 provides timing indication of radio transmissions for multimedia broadcast and multimedia multicast service packets (e.g., PDCP frames), maintains synchronization, and detects data losses in number of bytes as well as in number of packets. The multimedia broadcast and multimedia multicast service gateway and the broadcast/multicast service center include many of the subsystems corresponding to the subsystems of the base station and user equipment as described above.

Turning now to FIG. 7, illustrated is a control plane architecture of the systems architecture in supporting multimedia broadcast and multimedia multicast service single-frequency network operation including a multimedia broadcast and multimedia multicast service gateway control plane (designated “MBMS GW-CP”), a multi-cell multimedia broadcast and multimedia multicast service coordination entity (“MCE”), a base station(s) (designated “eNB”) and user equipment (designated “UE”). The control plane architecture radio interface stacks for multimedia broadcast and multimedia multicast service are similar to a long-term evolution unicast communication architecture. A radio resource controller (“RRC”) 650 and the multimedia broadcast and multimedia multicast service control channel (“MCCH”) are terminated in the base stations. The MCE is employed to control the single-frequency network operation. The MCE can be responsible for providing the contents of single-frequency network control signaling sent on single-frequency network transmitted MCCH(s) and controlling the transmission of such MCCH(s) as well as the single-frequency network operation. The MCE includes a dynamic single-frequency network subsystem 655 as well as an MCE interface subsystem 660 to provide an interface to communicate with base station(s).

The radio resource controller 650 provides, without limitation, multimedia broadcast and multimedia multicast service context handling (including bookkeeping), multimedia broadcast and multimedia multicast service radio bearer handling and control, MCCH transmission control at the base station, MCCH acquisition and reception of multimedia broadcast and multimedia multicast service control information, notification, radio bearer reconfiguration at the user equipment, and point-to-point procedures facilitating multimedia broadcast and multimedia multicast service operations, when needed.

Again, the control plane architecture supports long-term evolution multimedia broadcast and multimedia multicast service. A reporting subsystem (designated “Reporting S/S”) 670 in the user equipment is responsible for providing a counting report and channel quality indicator report to the base station(s) after receiving a counting report request or channel quality indicator report request. A counting report is an indication from the user equipment that is in-service (i.e., that it is active or idle) in the base station serving area. The base station then compiles a count of the number of in-service user equipment in its serving area and their associated channel quality indicator. A reporting subsystem 675 in the base station is responsible for broadcasting the counting report request and channel quality indictor report request to the user equipment in its service area. In addition, the reporting subsystem 675 in the base station is also responsible for processing the counting report and channel quality indicator report received from the user equipment, and summarizing the same via an activity status report.

For the purposes of the discussion herein, the terms nearby base station, neighboring base station, and base station in scope have an analogous meaning with respect to a subject base station. Typically, the aforementioned base stations are base stations in the subject base station's critical or gray zone as will become more apparent below. Additionally, the terms nearest base station and serving base station have an analogous meaning. In a mixed carrier multimedia broadcast and multimedia multicast service wherein both multimedia broadcast and multimedia multicast service and unicast service are provided, the serving base station is the base station from which the user equipment receives both unicast and multimedia broadcast and multimedia multicast service. In a dedicated carrier multimedia broadcast and multimedia multicast service, the serving base station is defined as the base station providing the strongest signal to the user equipment for the multimedia broadcast and multimedia multicast service.

In a distributed architecture, the reporting subsystem 675 in the base station is responsible for sending the activity status report to a dynamic single-frequency network subsystem (designated “dynamic SFN S/S”) 680 in a list of neighboring base stations. In a centralized architecture, the reporting subsystem 675 in the base stations is responsible for sending the activity status report to the dynamic single-frequency network subsystem in the MCE. The dynamic single-frequency network subsystem in the MCE is responsible for calculating a static contribution table as set forth herein.

In addition to calculating a static contribution table, in a centralized architecture, the dynamic single-frequency network subsystem 655 in the MCE is responsible for receiving the activity status report from base stations, and determine whether to turn on or off the multimedia broadcast and multimedia multicast service or reuse the base stations based on the static contribution table and received activity status reports. After a decision is made, the dynamic single-frequency network subsystem 655 in the MCE sends commands to the dynamic single-frequency network subsystem 680 of the base stations to control a behavior thereof. In addition to calculating a static contribution table in the distributed architecture, the dynamic single-frequency network subsystem 655 in the MCE decides for each base station a list of base stations whose critical zone or gray zone covers the base station based on the static contribution table and informs the base stations of the respective lists of base stations.

In the centralized architecture, the dynamic single-frequency network subsystem 680 in the base station is responsible for turning on or off or reusing a base station's transmission of multimedia broadcast and multimedia multicast service for other traffic based on the command from the MCE. In the distributed architecture, the dynamic single-frequency network subsystem 680 in the base station receives the activity status report from neighboring base stations. In addition, the dynamic single-frequency network subsystem 680 uses received activity status reports and the static contribution table to decide whether to turn on or off the multimedia broadcast and multimedia multicast service or reuse the resource in the base station for other traffic. Thus, the M2 interface as illustrated in FIG. 7 is principally used in accordance with the distributed architecture.

Regarding communication system performance, the distribution of user equipment in a multimedia broadcast single-frequency network area is not evenly distributed and, in some cases, certain base stations may not have any user equipment receiving multimedia broadcast and multimedia multicast service at all. In the latter case, it may be advantageous to cease the multimedia broadcast and multimedia multicast service transmissions from the idle base station to reduce the overall communication system power consumption. Furthermore, the unused multimedia broadcast and multimedia multicast service spectrum associated with the idle base station may be allocated for other resources such as unicast communications, thereby improving the communication system spectrum efficiency. A unicast communication is a form of point-to-point communication wherein information is transmitted from a single source to a single destination. When turning off a base station resource that is not providing multimedia broadcast and multimedia multicast service to user equipment, it is preferable to ensure the receiving quality of user equipment in other cells of the multimedia broadcast single-frequency network area.

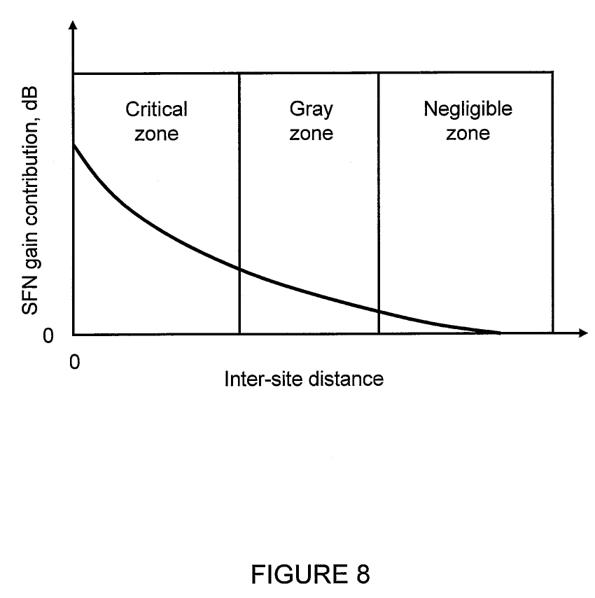

Turning now to FIG. 8, illustrated is a graphical representation of a static contribution table constructed according to the principles of the present invention. In one embodiment, the communication system as described herein estimates a subject base station's contribution to single-frequency network combining gain (in decibels (“dB”)) of the user equipment based on a distance from the subject base station to the user equipment's serving base station. In more general terms, the geographical relation between the base station and the user equipment's serving base station are used to estimate the contribution to single-frequency network combining gain of the user equipment. The geographical relation includes, without limitation, the distance between two base stations, distance from one base station to the far end or near end of the coverage of another base station (e.g., at most plus/minus one-half inter-site distance comparing with distance between two base stations), building, street layout, etc.

From the estimated single-frequency network combining gain contribution, the communication system segments the subject base stations in the network into three zones based on its geographical relation with the user equipment's serving base station denoted in the graphical representation of the static contribution table. The first zone is referred to as a critical zone, wherein the single-frequency network combining gain contribution from subject base station to the user equipment is important. The second zone is referred to as a negligible zone, wherein the single-frequency network combining gain contribution from the subject base station to the user equipment is marginal. The third zone is referred to as a gray zone, wherein the importance of the single-frequency network combining gain contribution depends on, for instance, the receiving channel quality of the user equipment. Since the estimation is typically done based on geographical relation between base stations, the static contribution table can be created before the multimedia broadcast and multimedia multicast services start. If there is no channel quality feedback from user equipment, which may occur temporarily, then the third zone may be a null zone (i.e., a zone spanning no area).

In an exemplary implementation employing a distributed approach, all base stations in a nearby area (also referred to as “nearby base stations,” which may be “neighboring base stations”) inform a subject base station of an operational status regarding a multimedia broadcast and multimedia multicast service thereof (e.g., on or off), counting information (e.g., is there any user equipment in multimedia broadcast and multimedia multicast service within the service area of the nearby serving base stations), and a channel quality indicator of the user equipment with the lowest channel quality in the service area of the nearby serving base stations.

The counting information is used by the subject base station or MCE to decide whether a multimedia broadcast and multimedia multicast service session is being transmitted in certain cells in a multimedia broadcast single-frequency network transmission mode. In a single cell transmission case, the counting information is used to determine whether a multimedia broadcast and multimedia multicast service session is transmitted via point-to-point or point-to-multipoint. The counting information is also used to determine if a single cell transmission or multimedia broadcast single-frequency network transmission mode is used for the multimedia broadcast and multimedia multicast service session. A counting procedure determines the number of user equipment interested in the given multimedia broadcast and multimedia multicast service in a cell, or to determine whether there are any interested user equipment in a given cell service area. While the communication system is not so limited, the counting procedure may include a counting request from the subject base station or the MCE, and a counting response from the user equipment to the subject base station or the MCE.

Based on the static contribution table and the user equipments' activity status reports (including counting information and channel quality indicator reports) received from nearby base stations, the communication system employs the following methodology. If there is at least one user equipment receiving multimedia broadcast and multimedia multicast service in the subject base station's critical zone, the subject base station's transmission of multimedia broadcast and multimedia multicast service should remain on. If all user equipment receiving multimedia broadcast and multimedia multicast service is within the subject base station's negligible zone, the multimedia broadcast and multimedia multicast service associated with the base station can be turned off. If no user equipment is in the critical zone, but at least one user equipment receiving multimedia broadcast and multimedia multicast service is in the subject base station's gray zone, the communication system decides whether to turn off the multimedia broadcast and multimedia multicast service associated with the subject base station based on user equipment channel quality indicator feedback, if available. If the channel quality feedback is not available, the subject base station should remain on with respect to the multimedia broadcast and multimedia multicast service.

For any base station, the communication system can either calculate its average signal strength in each cell based on, without limitation, inter-site/base station distance (“ISD”), transmission power, antenna pattern, and channel information, or measure and update the information in real time. Thus, the communication system can obtain a table that includes average added signal-to-interference and noise ratio (“SINR”) in every cell of each base station's transmission. In the case where the base stations transmit at equal power and all base stations are in a line of sight (“LOS”), the average added signal-to-interference and noise ratio of a base station's transmission mostly depends on the distance between the base station and the cell. Thus, the static contribution table can be pre-calculated and stored for usage. It should be noted that the serving base station in the graphical representation of FIG. 8 falls within the critical zone associated with the static contribution table.

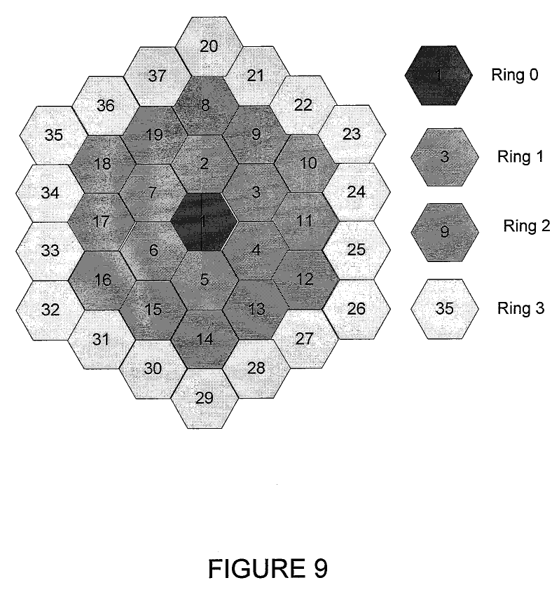

Turning now to FIG. 9, illustrated is a diagram representing a static contribution table constructed according to the principles of the present invention. In one embodiment, if equal inter-site/base station distance and same transmission power is applied in the communication network, the contribution table can be counted by the number of rings between two base stations. For example, FIG. 9 illustrates a multimedia broadcast single-frequency network area with four rings of multimedia broadcast and multimedia multicast service cells. Assuming that a user equipment in cell 1 (in ring 0) receives multimedia broadcast and multimedia multicast service signals from all of the base stations, the communication system can obtain the added signal-to-interference and noise ratio per base station transmission shown in TABLE I.

TABLE I

| | UE's own cell |
|---|---|
| Ring 0 | (reference) |
| One eNB in Ring 1 | 1 dB |
| One eNB in Ring 2 | 0.3 dB |
| One eNB in Ring 3 | 0.1 dB |
| eNBs in Ring >3 | negligible |

Note that the values in TABLE I are for illustration only. The actual values for a given multimedia broadcast single-frequency network depend on, for instance, the transmission power of the base stations, the inter-site/base station distance, the antenna pattern, and the channel status. TABLE I can be pre-calculated and/or measured in real time.

Regarding uplink feedback, an in-service user equipment should report its in-service existence in the network via a counting report to, for instance, its serving base station. The channel quality indicator feedback from the user equipment to the serving base station may also be employed. Thus, an activity status report of this cell includes counting information of this cell and a channel quality indicator report, that should be provided to those base stations whose critical zone or gray zone covers the base station in the distributed architecture, and that should be provided to the MCE in a centralized architecture.

The activity status report typically includes a base station's operational status regarding a multimedia broadcast and multimedia multicast service (e.g., on or off), the base station's counting information (i.e., the number of in-service user equipment within the service area of this base station) and the channel quality indicator feedback of the user equipment with the lowest channel quality. TABLE II shows one example of information in the activity status report sent between base stations.

TABLE II

| Information | | | |
|---|---|---|---|
| Element | Type | Example | Explanation |
| eNB ID | INTEGER | 1, 2, 3 | eNB identity |
| eNB | BOOLEAN | True/false | True: this eNB is transmitting |
| operational | | | MBMS signal. |
| status | | | False: this eNB is NOT |
| | | | transmitting MBMS signal. |
| eNB | BOOLEAN | True/false | True: at least one UE is |
| counting | | | receiving this MBMS from |
| result | | | this eNB |
| | | | False: no UE is receiving this |
| | | | MBMS from this eNB |
| CQI | DOUBLE | 18, 12, NA | Double value represent |
| | | | receiving power in dB scale |
| | | | NA: CQI feedback not |
| | | | available |

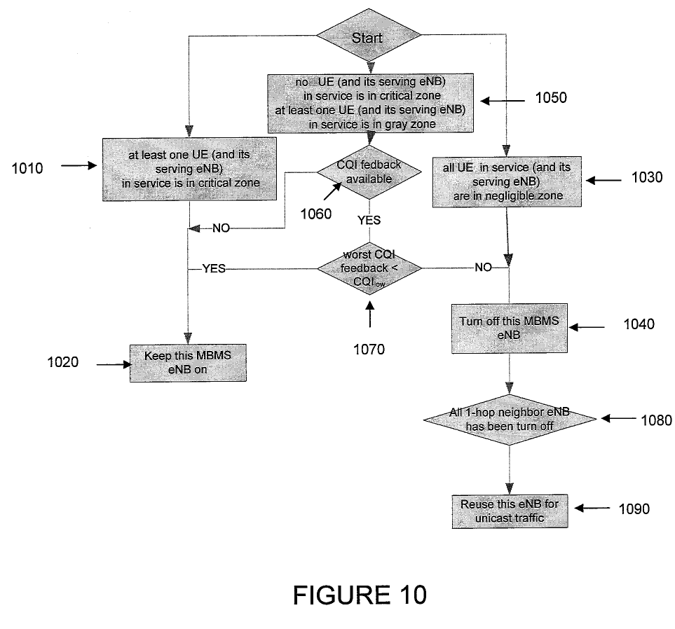

Turning now to FIG. 10, illustrated is a flow diagram of an embodiment of a method of operating a communication system constructed according to the principles of the present invention. In order to ensure multimedia broadcast and multimedia multicast service quality, generally a lower bound of received signal-to-interference and noise ratio (“SINR_{low}”) and channel quality indicator (“CQI_{low}”) is assumed. The method to turn on or off the transmission of a multimedia broadcast and multimedia multicast service in base stations, and reuse this resource for other purpose, is presented below.

If there is at least one user equipment receiving multimedia broadcast and multimedia multicast service in the subject base station's critical zone (see step 1010), the subject base station should be kept on (see step 1020). If all user equipment receiving multimedia broadcast and multimedia multicast service are within the subject base station's negligible zone (see step 1030), the subject base station's multimedia broadcast and multimedia multicast service can be turned off (see step 1040).

If no user equipment is in the critical zone, but at least one user equipment is in the gray zone (see step 1050), the communication system decides whether to turn off the subject base station's multimedia broadcast and multimedia multicast service based on the user equipment's channel quality indicator feedback, if available (see step 1060). If the channel quality indicator feedback is not available, the subject base station's multimedia broadcast and multimedia multicast service should remain on (see step 1020). If the channel quality indicator feedback representing the lowest channel quality is better than the lower bound channel quality indictor CQI_{low} (see step 1070), then the subject base station's multimedia broadcast and multimedia multicast service should be turned off (see step 1040). If the channel quality indicator feedback representing the lowest channel quality is less than the lower bound channel quality indictor CQI_{low} (see step 1070), then the subject base station's multimedia broadcast and multimedia multicast service should be turned on (see step 1020). If all nearby base stations are in an off-state regarding the multimedia broadcast and multimedia multicast service (see step 1080), the subject base station may use or request to use its multimedia broadcast and multimedia multicast service resources for other resources such as unicast communications, if needed (see step 1090).

By way of example, the communication system will employ the information provided in the activity status report of TABLE II and the base station's contribution to single-frequency network combining gain as provided in TABLE I. Suppose the predefined lower bound for the signal-to-interference and noise ratio SINR_{low} is 13 dB, and a third base station is a neighbor of a second base station. Assuming that turning on the multimedia broadcast and multimedia multicast service associated with one neighboring base station will increase the signal-to-interference and noise ratio by one dB as shown in TABLE I, then the multimedia broadcast and multimedia multicast service transmission of third base station will be turned on. On the other hand, if the signal-to-interference and noise ratio of all neighboring cells of the cell of a fourth base station is more than 14 dB, the fourth base station's multimedia broadcast and multimedia multicast service can be turned off because after turning off the fourth base station, the lowest signal-to-interference and noise ratios in all neighboring cells will be still above 13 dB.

The communication system as described herein can also determine a lower bound channel quality indictor CQI_{low} from, for instance, user equipment minimum signal-to-interference and noise ratio target SINR_{target} and static contribution table as set forth below.

CQI_{low}(X)=SINR_{target}+N(X)*contribution(X),

wherein X is the distance in number of rings from the subject base station to the base station in the gray zone, N(X) is the number of base stations in ring X whose gray zone covers the base station, and contribution (X) is single-frequency network combining gain of one base station in ring X. The lower bound channel quality indictor CQI_{low} is derived from the user equipment's minimum signal-to-interference and noise ratio target SINR_{target} plus a certain margin. The margin is the total single-frequency network combining gain from all base stations whose gray zone covers this base station.

Referring again to FIG. 9, assume that ring 3 cells belongs to the gray zone, and the communication system has a minimum signal-to-interference and noise ratio target SINR_{target} of 0 dB. Assuming the lower bound channel quality indictor CQI_{low} of user equipment in gray zone cell (cell 32) is 5 dB, cell 32 will send a signal to cell 1 about lowest channel quality indicator and other counting information. If the multimedia broadcast and multimedia multicast service associated with cell 1 is turned off, expect a 0.1 dB loss on signal-to-interference and noise ratio user equipment in cell 32. If all the multimedia broadcast and multimedia multicast service associated with ring 3 cells of cell 32 (including cell 1, 7, 18, 35, 5, 14, 29) are turned off, this will cause a 1.8 dB total loss on user equipment in cell 32. If the signal-to-interference and noise ratio of user equipment with the lowest channel quality indicator minus the loss of all those ring 3 cells (cells 1, 7, 18, 35, 5, 14, 29) are still above the minimum signal-to-interference and noise ratio target SINR_{target}, the multimedia broadcast and multimedia multicast service associated with cell 1 can be turned off.

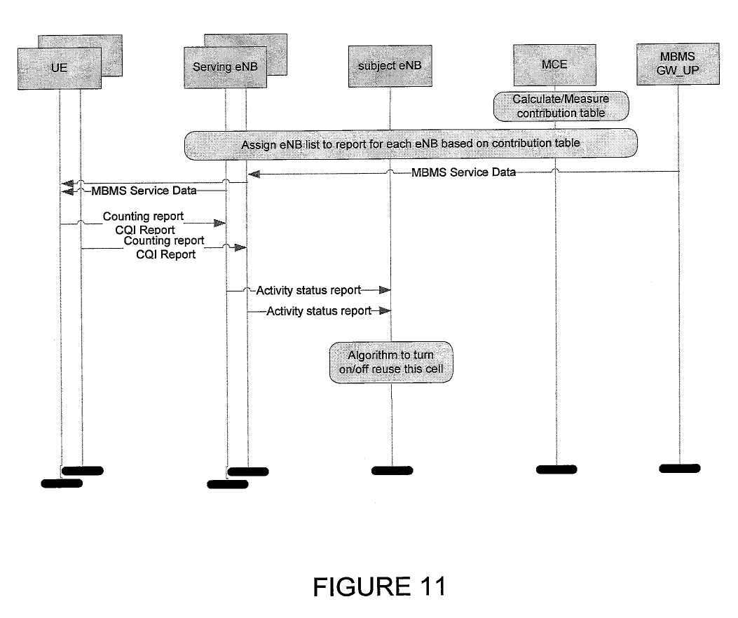

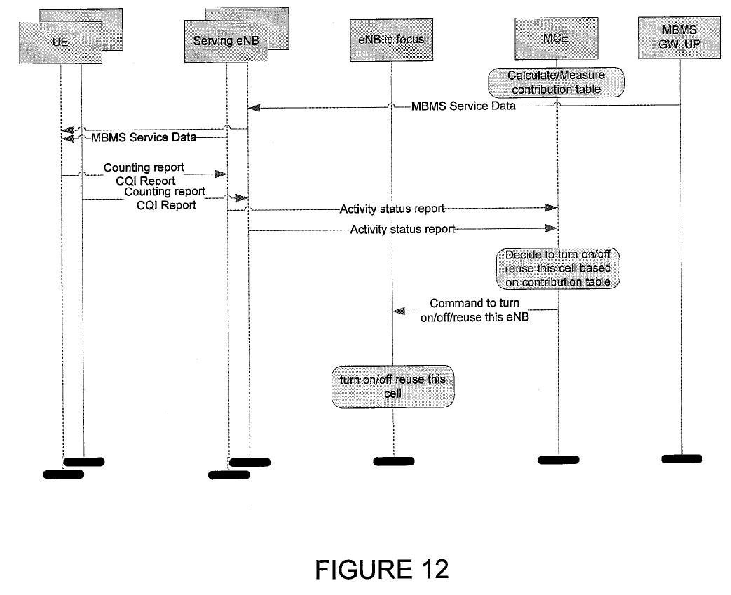

Turning now to FIGS. 11 and 12, illustrated are signaling diagrams demonstrating exemplary operations of a communication system according to the principles of the present invention employing a distributed architecture and a centralized architecture, respectively. The signals for the distributed architecture can be used in light multimedia broadcast and multimedia multicast service deployment, while the signals for centralized architecture can be used in a general multimedia broadcast and multimedia multicast service deployment.

Regarding the distributed architecture as illustrated in FIG. 11, the communication system is principally operated by each base station. During a configuration phase, the MCE calculates the static contribution table for each base station based on geographical layout of the base stations. This process is similar to neighboring cell list measurement process in UTRAN, which may include a simulation procedure to create the static contribution table, and also include some field measurement experiments to verify/calibrate the static contribution table. Then, the MCE decides for each subject base station a list of base stations whose critical zone or gray zone covers the subject base station. Thereafter, the MCE provides the base station lists to each subject base station.

After a multimedia broadcast and multimedia multicast services begin, MBMS GW-UP transmits multimedia broadcast and multimedia multicast service data (e.g., a mobile television program) to each base station. Then, each base station broadcasts the multimedia broadcast and multimedia multicast service data in bit-identical format. The user equipment combines the signals from multiple base stations, and decodes the multimedia broadcast and multimedia multicast service data. During operation, the user equipment provides counting reports and, potentially, channel quality indicator reports to its serving base station. Each base station summarizes the counting report and channel quality indicator report from the user equipment to compose an activity status report (an example of which is provided in Table II). This activity status report is sent to all base stations in the base station list provided by the MCE. If the channel quality indicator report from the user equipment is not available, the serving base station will not include the channel quality indicator report in the activity status report. Based on the received activity status report, each base station decides whether to turn on/off or reuse the radio resource reserved for multimedia broadcast and multimedia multicast service for other purposes. Inasmuch as each base station decides whether to turn on or off transmission of multimedia broadcast and multimedia multicast service, the signaling is sent to the base stations thereby affected.

In a centralized architecture as illustrated in FIG. 12, the MCE is responsible for turning on/off/reuse of the multimedia broadcast and multimedia multicast service associated with the base stations in the communication network. This avoids initial configuration signaling, but results in more signaling between the MCE and base stations after multimedia broadcast and multimedia multicast services begin. Before the session starts, the MCE calculates the contribution table for each base station based on a geographical layout of the base stations. This process is similar to neighboring cell list measurement process in UTRAN, which may include a simulation procedure to create a static contribution table, and also include some field measurement experiments to verify/calibrate the static contribution table. Then, the MCE decides for each subject base station a list of base stations whose critical zone or gray zone covers the subject base station.

After multimedia broadcast and multimedia multicast service session starts, the user equipment periodically provides a counting report and, potentially, a channel quality indicator report to its serving base station. Each base station summarizes the counting and channel quality indicator report to compose an activity status report. The activity status report is sent to the MCE periodically. If the channel quality indictor report from the user equipment is not available, the serving base station should not include the channel quality indicator information in the summarized activity status report to the MCE. Based on the static contribution tables for each base station and received activity status report, the MCE decides whether a base station's transmission of multimedia broadcast and multimedia multicast service should be turned on/off the resource should be reused for other purposes. If the MCE decides to change the operation status of one base station, it will send a message to that base station to control its behavior.

If a base station does not transmit a multimedia broadcast and multimedia multicast services signal, the base station can request the MCE to allow the base station to use the multimedia broadcast and multimedia multicast services frequency spectrum for other resources such as unicast communications. Upon receiving the request, the MCE will check the neighboring cells of the requested base station. If all the neighboring base stations are in an off state with respect to the multimedia broadcast and multimedia multicast service, the MCE sends an OKAY command back to the requesting base station to allow the request. If some of the neighboring base stations are in on state but can be turned off with respect to the multimedia broadcast and multimedia multicast service, or their transmission powers can be reduced without putting any user equipment below the lower bound for the signal-to-interference and noise ratio SINR_{low}, the MCE will first send commands to turn off or reduce the transmission powers of those base stations associated with the multimedia broadcast and multimedia multicast service, and then send an OKAY command back to the requesting base station to allow the request. Otherwise, the MCE will send a NO command back to the requesting base station to deny the request.

In the description above, it is assumed that if all direct neighbors (cells one hop, or one inter-site/base station distance away) are in an off state with respect to the multimedia broadcast and multimedia multicast service, this cell can be reused for other purposes such as a unicast communication. Of course, a similar contribution table approach using critical/gray/negligible zone can be employed in lieu of the one hop cell distance. Depending on the objective of reuse (reuse to transmit another multimedia broadcast and multimedia multicast service or reuse for other purposes such as for unicast communication), a cell may have a different “critical zone.” If all cells in the critical zone are already off with respect to the multimedia broadcast and multimedia multicast service, this cell is allowed to reuse its resource for other purposes.

As a result, the communication system may reduce multimedia broadcast and multimedia multicast service transmissions while maintaining the service quality. The communication system will also allow base stations without user equipment to use the resources reserved for multimedia broadcast and multimedia multicast service for other purposes such as unicast communications or other multimedia broadcast and multimedia multicast services. The communication system further provides for dynamic monitoring and adjusting of the multimedia broadcast and multimedia multicast service quality.

The communication system is configured to provide for a dynamic single-frequency network (i.e., how to turn on/off reuse multimedia broadcast and multimedia multicast service cells). The communication system also uses geographical relationships between base stations to calculate a static contribution table, wherein “static” means that the contribution table does not change due to user equipment movement. The communication system also composes per-cell activity status reports by summarizing counting and channel quality indicator reports from the user equipment. The communication system can use the activity status report and the static contribution table to decide how to turn on/off the multimedia broadcast and multimedia multicast service associated and reuse cells.

In distributed architecture (employable with a light multimedia broadcast and multimedia multicast service), the communication system uses the static contribution table to decide a list of neighboring base stations to forward the activity status report to. The list of neighboring base stations is configured in each base station by signaling from a multimedia broadcast and multimedia multicast service coordination entity (“MCE”). The base stations forward the activity status report to those base stations in the list of neighboring base stations. Using the activity status report and static contribution table configured by the MCE, a base station decides to turn on/off the multimedia broadcast and multimedia multicast service or reuse its resource for other purposes.

In a centralized architecture (employable with a general multimedia broadcast and multimedia multicast service), a static contribution table is created and stored in the MCE. The base stations compose activity status reports from counting information and channel quality indicator information received from user equipment, and periodically reported to the MCE. The MCE decides each base station's operational status based on a static contribution table and received activity status reports. Finally, the MCE commands each base station's behavior (on/off of the multimedia broadcast and multimedia multicast service or reuse for other purpose).

As described above, the exemplary embodiment provides both a method and corresponding apparatus consisting of various modules providing functionality for performing the steps of the method. The modules may be implemented as hardware (including an integrated circuit such as an application specific integrated circuit), or may be implemented as software or firmware for execution by a computer processor. In particular, in the case of firmware or software, the exemplary embodiment can be provided as a computer program product including a computer readable storage structure embodying computer program code (i.e., software or firmware) thereon for execution by the computer processor.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof, as described herein. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus for use with a communication system, comprising:
a reporting subsystem configured to compile an activity status report based on a counting report and a channel quality indicator report received from user equipment and to send said activity status report to an entity of said communication system; and
a dynamic single-frequency network subsystem configured to control a multimedia broadcast and multimedia multicast service provided by said apparatus as a function of a static contribution table associated therewith and said activity status report.

2. The apparatus as recited in claim 1 wherein said entity is a base station or a multi-cell multimedia broadcast and multimedia multicast service coordination entity.

3. The apparatus as recited in claim 1 wherein said dynamic single-frequency network subsystem is configured to control a multimedia broadcast and multimedia multicast service provided by said apparatus in response to a command received from a multi-cell multimedia broadcast and multimedia multicast service coordination entity.

4. The apparatus as recited in claim 1 wherein said static contribution table is derived by a multi-cell multimedia broadcast and multimedia multicast service coordination entity of said communication system.

5. The apparatus as recited in claim 1 wherein said static contribution table is a function of a geographical layout of said apparatus with other entities of said communication system.

6. The apparatus as recited in claim 1 wherein said reporting subsystem and said dynamic single-frequency network subsystem are formed as integrated circuits on chips.

7. An apparatus for use with a communication system, comprising:
means for compiling an activity status report based on a counting report and a channel quality indicator report received from user equipment;
means for sending said activity status report to an entity of said communication system; and
means for controlling a multimedia broadcast and multimedia multicast service provided by said apparatus as a function of a static contribution table associated therewith and said activity status report.

8. The apparatus as recited in claim 7 wherein said static contribution table is a function of a geographical layout of said apparatus with other entities of said communication system.

9. For use with a communication system, a computer program product comprising program code stored in a computer readable medium configured to compile an activity status report based on a counting report and a channel quality indicator report received from user equipment, send said activity status report to an entity of said communication system, and control a multimedia broadcast and multimedia multicast service provided by said apparatus as a function of a static contribution table associated therewith and said activity status report.

10. The computer program product as recited in claim 9 wherein said static contribution table is a function of a geographical layout of said apparatus with other entities of said communication system.

11. A method of operating an entity of a communication system, comprising:
compiling an activity status report based on a counting report and a channel quality indicator report received from user equipment;
sending said activity status report to another entity of said communication system; and
controlling a multimedia broadcast and multimedia multicast service provided by said entity as a function of a static contribution table associated therewith and said activity status report.

12. The method as recited in claim 11 wherein said another entity is a base station or a multi-cell multimedia broadcast and multimedia multicast service coordination entity.

13. The method as recited in claim 11 wherein said controlling is performed in response to a command received from a multi-cell multimedia broadcast and multimedia multicast service coordination entity.

14. The method as recited in claim 11 wherein said static contribution table is derived by a multi-cell multimedia broadcast and multimedia multicast service coordination entity of said communication system.

15. The method as recited in claim 11 wherein said static contribution table is a function of a geographical layout of said entity with other entities of said communication system.

16. An apparatus operable in a single-frequency network associated with a communication system, comprising:
a dynamic single-frequency network subsystem configured to receive an activity status report associated with user equipment from a base station, derive a static contribution table associated with said base station, and produce a command to control a behavior of said base station as a function of said activity status report and said static contribution table; and
an interface subsystem configured to send said command to said base station.

17. The apparatus as recited in claim 16 wherein said activity status report is based on a counting report and a channel quality indicator report received from said user equipment.

18. The apparatus as recited in claim 16 wherein said static contribution table is a function of a geographical layout of said base station with other entities of said communication system.

19. The apparatus as recited in claim 16 wherein said static contribution table includes zones as a function of geographical relation between an entity of said communication system and said base station to estimate a single-frequency network combining gain contribution of said user equipment.

20. The apparatus as recited in claim 16 wherein said dynamic single-frequency network subsystem is configured to produce said command to:
leave on a multimedia broadcast and multimedia multicast service associated with said base station if at least one user equipment is receiving a multimedia broadcast and multimedia multicast service in a critical zone thereof;
turn off said multimedia broadcast and multimedia multicast service associated with said base station if all user equipment receiving multimedia broadcast and multimedia multicast service is within a negligible zone thereof; and
turn off said multimedia broadcast and multimedia multicast service associated with said base station if no user equipment is in said critical zone thereof and at least one user equipment receiving multimedia broadcast and multimedia multicast service is a gray zone thereof, and if user equipment channel quality indicator report related to said base station is available in said activity status report.

21. The apparatus as recited in claim 16 wherein said dynamic single-frequency network subsystem and said interface subsystem are formed as integrated circuits on chips.

22. An apparatus operable in a single-frequency network associated with a communication system, comprising:
means for receiving an activity status report associated with user equipment from a base station;
means for deriving a static contribution table associated with said base station;
means for producing a command to control a behavior of said base station as a function of said activity status report and said static contribution table; and
means for sending said command to said base station.

23. The apparatus as recited in claim 22 wherein said means for producing said command includes:
leaving on a multimedia broadcast and multimedia multicast service associated with said base station if at least one user equipment is receiving a multimedia broadcast and multimedia multicast service in a critical zone thereof;
turning off said multimedia broadcast and multimedia multicast service associated with said base station if all user equipment receiving multimedia broadcast and multimedia multicast service is within a negligible zone thereof; and
turning off said multimedia broadcast and multimedia multicast service associated with said base station if no user equipment is in said critical zone thereof and at least one user equipment receiving multimedia broadcast and multimedia multicast service is a gray zone thereof, and if user equipment channel quality indicator report related to said base station is available in said activity status report.

24. For use in a single-frequency network associated with a communication system, a computer program product comprising program code stored in a computer readable medium configured to receive an activity status report associated with user equipment from a base station, derive a static contribution table associated with said base station, produce a command to control a behavior of said base station as a function of said activity status report and said static contribution table, and send said command to said base station.

25. The computer program product as recited in claim 24 wherein said program code stored in a computer readable medium is configured to:
leave on a multimedia broadcast and multimedia multicast service associated with said base station if at least one user equipment is receiving a multimedia broadcast and multimedia multicast service in a critical zone thereof;
turn off said multimedia broadcast and multimedia multicast service associated with said base station if all user equipment receiving multimedia broadcast and multimedia multicast service is within a negligible zone thereof; and
turn off said multimedia broadcast and multimedia multicast service associated with said base station if no user equipment is in said critical zone thereof and at least one user equipment receiving multimedia broadcast and multimedia multicast service is a gray zone thereof, and if user equipment channel quality indicator report related to said base station is available in said activity status report.

26. A method operable in a single-frequency network associated with a communication system, comprising:
receiving an activity status report associated with user equipment from a base station;
deriving a static contribution table associated with said base station;
producing a command to control a behavior of said base station as a function of said activity status report and said static contribution table; and
sending said command to said base station.

27. The method as recited in claim 26 wherein said activity status report is based on a counting report and a channel quality indicator report received from said user equipment.

28. The method as recited in claim 26 wherein said static contribution table is a function of a geographical layout of said base station with other entities of said communication system.

29. The method as recited in claim 26 wherein said static contribution table includes zones as a function of geographical relation between an entity of said communication system and said base station to estimate a single-frequency network combining gain contribution of said user equipment.

30. The method as recited in claim 26 wherein said producing said command includes:
leaving on a multimedia broadcast and multimedia multicast service associated with said base station if at least one user equipment is receiving a multimedia broadcast and multimedia multicast service in a critical zone thereof;
turning off said multimedia broadcast and multimedia multicast service associated with said base station if all user equipment receiving multimedia broadcast and multimedia multicast service is within a negligible zone thereof; and
turning off said multimedia broadcast and multimedia multicast service associated with said base station if no user equipment is in said critical zone thereof and at least one user equipment receiving multimedia broadcast and multimedia multicast service is a gray zone thereof, and if user equipment channel quality indicator report related to said base station is available in said activity status report.
